(19) United States
(12) Patent Application Publication
(10) Pub. No.: US 2004/0255928 A1
(43) Pub. Date: Dec. 23, 2004

(54) Muffle for a cooking device and method for producing the muffle

(75) Inventors: Franz Deubzer, Altenmarkt (DE); Peter Matauschek, Traunstein (DE); Hans Schuhegger, Petting (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/873,398

(22) Filed: Jun. 21, 2004

Related U.S. Application Data
(63) Continuation of application No. PCT/EP02/13460, filed on Nov. 28, 2002.

(30) Foreign Application Priority Data
Dec. 21, 2001 (DE) 101 63 183.9

(51) Int. Cl. A21B 1/00

(52) U.S. Cl. 126/273 R; 29/890.08

(57) ABSTRACT

Muffles for cooking devices are preferably formed with an enameled layer on the inner side. The muffles contain at least two sheet metal ends that are connected together by welding. A first sheet metal end disposed on the inner side covers a second sheet end disposed on the outer side and forms a step-type transition between the two sheet end with the front surface of the sheet edge thereof. In order to prevent uneven edges in the enamel layer in the region of the step-type transition, the inner side of the first sheet end is flattened to a wedge-shaped form in the direction of the front side of the sheet edge.

### CROSS-REFERENCE TO RELATED APPLICATION

This application is a continuation, under 35 U.S.C. § 120, of copending international application No. PCT/EP02/13460, filed Nov. 28, 2002, which designated the United States; this application also claims the priority, under 35 U.S.C. § 119, of German patent application No. 101 63 183.9, filed Dec. 21, 2001; the prior applications are herewith incorporated by reference in their entirety.

### BACKGROUND OF THE INVENTION

Field of the Invention

The present invention relates to a muffle and to a method for producing the muffle. The muffle has at least two metal sheet ends, which are connected to one another by a weld seam, of which sheet ends an interior, first sheet end overlaps an exterior, second sheet end. The first sheet end forms with its end sheet edge a step-shaped transition between the sheet-metal layers.

A muffle of a cooking device usually has metal sheet ends that are disposed overlapped and are welded to one other. This produces step-shaped transitions between the two sheet ends on the inner side of the muffle. During an enameling operation, breaking away of the enamel slip, and consequently an undesirably rough enamel surface, may occur at these step-shaped transitions. An enamel surface roughened in this way is referred to as a distressed edge.

A method for connecting two metal sheets, in particular two sheets of a vehicle body, by a mash seam weld is disclosed in German Patent DE 42 08 596 C2. Mash seam welding is a special form of roller seam welding of overlapped sheets. In this case, the roller electrodes do not extend in the sheet but on only the overlapped edges of the sheets. The zones that become malleable under the effect of the current are simultaneously welded by the electrode force and leveled almost to the thickness of a single sheet. The weld seam that has been leveled on one side can be enameled without any problem and without distressed edges being formed by the enamel slip breaking away.

### SUMMARY OF THE INVENTION

It is accordingly an object of the invention to provide a muffle for a cooking device and a method for producing the muffle which overcome the above-mentioned disadvantages of the prior art devices and methods of this general type, with which a break-free enamel surface is made possible in a simple way in the connecting region of sheet parts forming the muffle.

With the foregoing and other objects in view there is provided, in accordance with the invention, a muffle for a cooking device. The muffle contains a first sheet metal layer having a first sheet end and an inner side coated with an enamel layer, and a second sheet metal layer having a second sheet end. The first and second sheet ends are connected to each other by a weld seam. The first sheet end is an interior, first sheet end overlapping the second sheet end being an exterior, second sheet end. The first sheet end has an end sheet edge with a step-shaped transition between the first and second sheet metal layers. The interior, first sheet end has a wedge-shaped form in a direction of the end sheet edge.

Accordingly, the interior, first sheet end is flattened in a wedge-shaped form in the direction of it is end sheet edge. The interior step-shaped transition between the sheet ends is consequently largely leveled. During the enameling of the inner side of the muffle, the enamel slip therefore does not break away in the region of the step-shaped transition. On account of the wedge geometry according to the invention of the interior sheet end, distressed edges in the enamel surface in the region of the overlapping sheet ends are consequently avoided.

In a particularly advantageous configuration of the invention, the sheet thickness or the edge height at the extreme end of the interior sheet end is reduced to 0 to 0.20 mm. In this case, a maximum permissible value of the end sheet thickness is dependent on the layer thickness of the enamel layer. For example, in the case of an enamel layer thickness of 150 μm, an end sheet thickness of at most 0.18 mm is permissible. In the case of an enamel layer thickness of 120 μm, end sheet thicknesses of up to 0.15 mm are permissible without distressed edges forming. The enamel layer fulfils the purpose of protecting the muffle sheet from corrosion. The enamel layer is preferably configured to be as thin as possible, in order to prevent stress cracks, for example when the cooking device is used for pyrolysis.

To simplify the production of the muffle, vertically precut sheets can be used. The extreme end of the sheet ends therefore extends vertically, whereby a pronounced step-shaped transition is obtained between the overlapping sheet ends. By the wedge geometry according to the invention, a smooth enamel layer can be achieved at the interior sheet end—in spite of the vertical cut of the muffle sheets.

The angle of slope of the wedge surface formed according to the invention of the first sheet end that is flattened in a wedge-shaped manner may lie between 10 and 35°, in particular at 20°. With this angle of slope, an adequately smooth transition for the enamel slip is achieved.

In an embodiment of the invention that is simple in production engineering terms, the wedge surface is formed in a planar manner. Such a planar wedge surface can be produced particularly simply using a roller rolling method. The transition between the sheet ends can be further smoothed by the wedge surface being convexly curved.

For a particularly smooth transition between the sheet ends, the wedge surface of the second sheet end that is flattened in a wedge-shaped manner may extend in the manner of an inflectional line with respect to its end sheet edge.

The width of the interior sheet end that is flattened in a wedge-shaped manner can advantageously be less than an edge distance of a weld seam connecting the sheet ends. As a result, the wedge geometry of the interior sheet end is not impaired during a welding operation.

In a further configuration of the invention, a sealing lip that extends along the extreme end may be formed at the extreme end of the overlapping interior sheet end. The sealing lip is in a pressure contact, preferably in linear contact, with the first sheet end. This prevents liquids or contaminants that can impair the subsequent enameling operation from getting into a gap formed between the sheet ends after a welding operation.

In a preferred configuration of the invention, the weld seam may be formed as a spot weld seam. Introduction of excessive heat into the sheet ends is prevented by spot welding. Thermally induced deformations of the sheet ends during welding are consequently avoided. It is of advantage in this case if the weld spots are spaced apart at intervals of 5-7 mm. This ensures adequately low introduction of heat and that the sheet ends are welded to one another with a seal of adequate integrity.

In a particularly preferred method for producing the muffle for the cooking device, the wedge surface may be produced by a low-cost cold forming of the edge region of the overlapped sheet end on the cooking space side.

The cold forming can be performed particularly effectively by a roller rolling method. In this case, the sheet thicknesses used according to the invention of between 0.4 and 0.8 mm, in particular 0.5 mm, are advantageous. On the one hand, a sheet end with such a sheet thickness is low in cost. On the other hand, with this sheet thickness, excessive displacement of material during a cold forming operation is avoided. Deformations in the sheet end caused by material displacement can consequently be prevented. As a consequence, an aimed for wedge geometry can be formed much more easily than with sheet thicknesses which are greater than 0.8 mm.

Other features which are considered as characteristic for the invention are set forth in the appended claims.

Although the invention is illustrated and described herein as embodied in a muffle for a cooking device and a method for producing the muffle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective, partial sectional view of a detail of a first exemplary embodiment of a muffle for a cooking device according to the invention;

FIG. 2 is a perspective view of the muffle corresponding to FIG. 1 without an enamel layer;

FIG. 3 is a diagrammatic, side sectional view of two welded sheet ends according to a second exemplary embodiment of the invention;

FIG. 4 is a diagrammatic, side sectional view of two welded sheet ends according to a third exemplary embodiment;

FIG. 5 is a diagrammatic, side sectional view of two welded sheet ends according to a fourth exemplary embodiment; and

FIG. 6 is a simplified block diagram that outlines a method for producing the muffle.

### DESCRIPTION OF THE PREFERRED EMBODIMENTS

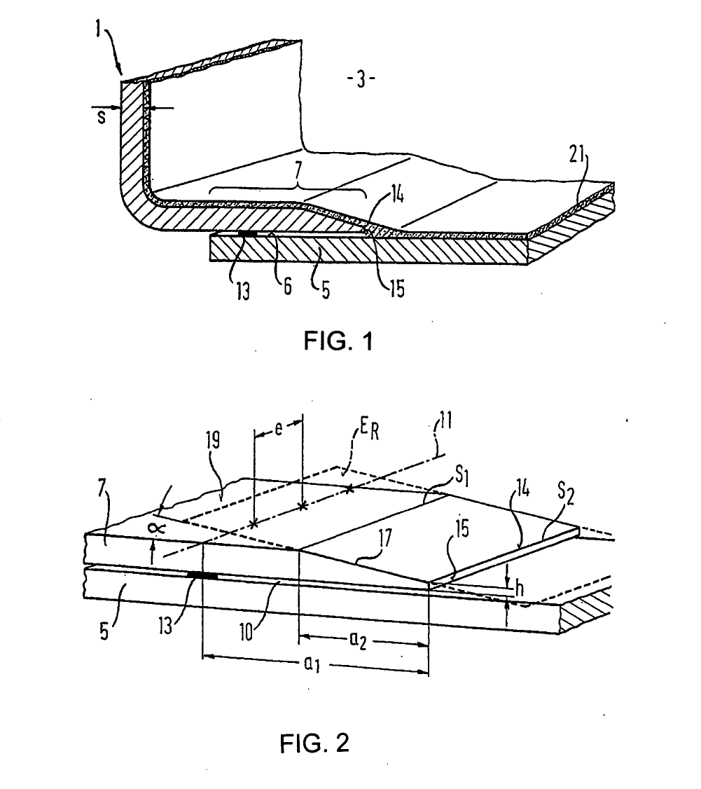

Referring now to the figures of the drawing in detail and first, particularly, to FIG. 1 thereof, there is shown an enlarged detail of a muffle 1 for a baking oven. The muffle 1 encloses a cooking space 3 and has a first sheet end 7 and a second sheet end 5. A sheet thickness s of the muffle sheet is 0.5 mm. To connect the two sheet ends 5, 7, the interior, first sheet end 7 overlaps the exterior, second sheet end 5. As FIG. 1 reveals, in this case the interior sheet end 7 lies flat on the second sheet end 5. The two sheet ends 5 and 7 are connected to each other by a spot weld seam 13. The weld spots thereby produced are disposed at an edge distance a₁ of approximately 4 mm from a vertical extreme end 15 of the first sheet end 7. According to FIG. 1, the sheet thickness s is reduced to approximately 0.18 mm at the vertical extreme end 15. The interior, first sheet end 7 is in this case flattened in a wedge-shaped manner in the direction of its end sheet edge 14. A wedge surface 17 is in this case formed as a planar sloping surface, which forms a first edge line S₁ with the inner side 19 of the muffle sheet. In the same way, a second edge line S₂ is formed between the vertical extreme end 15 of the second sheet end 7 and the wedge surface 17. The two edge lines S₁ and S₂ define a wedge plane E_{R}. According to FIG. 1, the wedge plane E_{R} forms an angle of slope α of about 20° with the inner side 19 of the muffle. The transitions in the region of the edge lines S₁ and S₂ are preferably rounded off. A width a₂ of the sheet end 7 that is flattened in a wedge-shaped form is kept smaller than the edge distance a₁ of the weld seam 11. Consequently, the weld spots of the weld seam are not provided in the region of the wedge surface 17. Impairment of the wedge geometry by the weld seam 13 is consequently avoided. The weld spots of the weld seam 13 are spaced apart at intervals of about 6 mm. On the one hand, this permits adequate integrity of the seal between the first and second sheet ends. On the other hand, the amount of heat to which the sheet ends 5 and 7 are subjected during the welding operation is sufficiently low—in comparison with a continuously formed weld seam, as is necessary in the case of mash seam welding.

According to FIG. 1, the sheet ends S and 7 of the muffle 1 are coated with an enamel layer 21, the average layer thickness of which is about 150 μm. On account of the flattened wedge surface 17, the enamel layer 21 has a break-free surface in the region between the first and second sheet ends 5, 7. The surface of the enamel layer 21 therefore extends smoothly over the extreme end 15 of the first sheet end 7, without forming disadvantageous distressed edges.

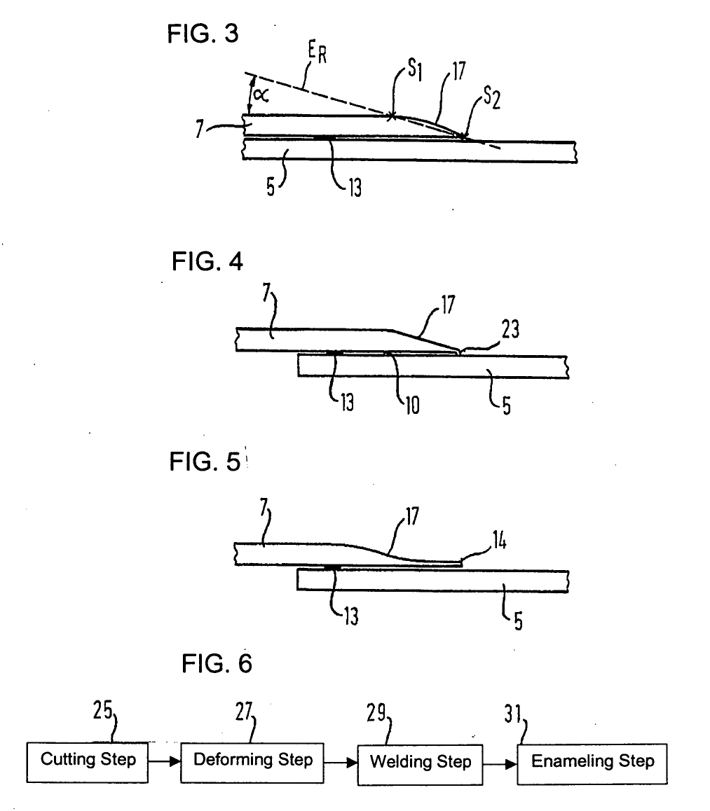

In FIG. 3, a second exemplary embodiment is shown in a schematic side sectional view. This reveals that—as in the first exemplary embodiment—the wedge plane E_{R} indicated by a dashed line forms a wedge angle α of about 20°. As a difference from the first exemplary embodiment, the wedge surface 17 is formed with a convex curve and protrudes out of the wedge plane E_{R}. In this exemplary embodiment, the sheet thickness s at the extreme end 15 is 0 mm; i.e. the first sheet end 7 extends to its extreme end 15 at an acute angle. As a result, the transition between the sheet ends is smoothed to an even greater extent.

Represented in FIG. 4 is a third exemplary embodiment, in which a sealing lip 23 is formed at the vertical extreme end 15 of the first sheet end 7. The sealing lip 23 is formed on the underside of the first sheet end 7, facing the second sheet end 5. As shown, the sealing lip 23 is pressed in a linear contact with the second sheet end 5. As a result, a gap 10 between the first and second sheet ends 5, 7 is closed. Liquids or contaminants therefore cannot get into the gap 10 after the welding operation and impair the subsequent enameling operation.

In FIG. 5, a fourth exemplary embodiment is sketched in a schematic side view. Here, the sheet end 7 that is flattened in a wedge-shaped form is curved in the manner of an inflectional line with respect to the end sheet edge 14 for a particularly smooth transition between the sheet ends 5, 7.

In the block diagram according to FIG. 6, the basic method for producing the muffle 1 is indicated. Accordingly, in a first method step 25, the sheet ends 5 and 7 are cut vertically to the exact dimensions. Subsequently, in a deforming step 27, the second sheet end 7 is cold-formed, whereby the wedge surface 17 is formed. On account of the sheet thickness s that is used, of 0.5 mm, advantageously only a slight material displacement is caused in the sheet end 7 during the cold forming. Undesired deformations in the region of the sheet end 7 induced by the material displacement are therefore largely avoided. The transition between the sheet ends 5 and 7 is consequently not impaired by material displacements.

In a subsequent welding step 29, the sheet ends 5, 7 are welded to one another by a welding method. Any desired welding methods are used, for example a spot welding, roller spot welding, roller seam welding or laser welding method. The spot welding method has proven to be particularly advantageous. In the welding method, the amount of heat supplied is comparatively low. As a result, thermally induced deformations of the sheet ends 5, 7 can be avoided. In a subsequent working step 31, the sheet ends 5, 7 are subjected to an enameling process, in which the sheet ends 5, 7 are coated with the enamel layer 21 of a layer thickness of from 80 to 120 μm. The enamel layer fulfils the purpose of protecting the sheet ends from corrosion. The enamel layer is advantageously configured to be as thin as possible, in order to prevent stress cracks, for example in pyrolysis operation.

We claim:

1. A muffle for a cooking device, the muffle comprising:
a first sheet metal layer having a first sheet end and an inner side coated with an enamel layer; and
a second sheet metal layer having a second sheet end, said first and second sheet ends connected to each other by a weld seam, said first sheet end being an interior, first sheet end overlapping said second sheet end being an exterior, second sheet end;
said first sheet end having an end sheet edge with a step-shaped transition between said first and second sheet metal layers, said interior, first sheet end having a wedge-shaped form in a direction of said end sheet edge.

2. The muffle according to claim 1, wherein said first sheet end is flattened to said wedge-shaped form on said inner side.

3. The muffle according to claim 1, wherein said end sheet edge has an edge height lying between 0 and 0.2 mm.

4. The muffle according to claim 1, wherein said first sheet end has an extreme end extending vertically in relation to said inner side of said first sheet metal layer.

5. The muffle according to claim 1, wherein said wedge-shaped form has a slope angle lying between 10 and 35°.

6. The muffle according to claim 5, wherein said first sheet end with said wedge-shaped form is convexly curved toward said inner side of the muffle.

7. The muffle according to claim 5, wherein said first sheet end with said wedge-shaped form is curved in a manner of an inflectional line with respect to said end sheet edge.

8. The muffle according to claim 1, wherein said first and second sheet metal layers each have a sheet thickness of between 0.4 and 0.8 mm.

9. The muffle according to claim 1, wherein said weld seam extends parallel to said end sheet edge, and a distance between said weld seam and said end sheet edge lies between 3 and 6 mm.

10. The muffle according to claim 9, wherein said weld seam is formed by weld spots that are spaced apart at intervals of between 5 and 7 mm.

11. The muffle according to claim 9, wherein said distance is greater than a width of said first sheet end with said wedge-shaped form.

12. The muffle according to claim 4, further comprising a sealing lip extending along and disposed at said extreme end of said first sheet end, and said sealing lip is pressed in contact with said second sheet end.

13. The muffle according to claim 5, wherein said slope angle is at 20°.

14. The muffle according to claim 8, wherein said sheet thickness is approximately 0.5 mm.

15. A method for producing a muffle for a cooking device, which comprises the steps of:
disposing at least two sheet ends to overlap one another, the two sheet ends including an interior, first sheet end overlapping an exterior, second sheet end, the interior, first sheet end having an end sheet edge forming a step-shaped transition between the two sheet ends on an inner side of the muffle;
flattening the interior, first sheet end into a wedge-shape extending in a direction of the end sheet edge;
subsequently welding the two sheet ends to one another; and
enameling the inner side of the first sheet end.

16. The method according to claim 15, which further comprises cutting the interior, first sheet end vertically before performing the flattening step.

17. The method according to claim 15, which further comprises using a roller and a rolling method for flattening the interior, first sheet end into the wedge-shape.

18. The method according to claim 15, wherein the interior, first sheet end has a sheet thickness of between 0.4 and 0.8 mm.

19. The method according to claim 15, wherein the interior, first sheet end has a sheet thickness of approximately 0.5 mm.
